(19) United States
(12) Patent Application Publication
(10) Pub. No.: US 2025/0284691 A1
(43) Pub. Date: Sep. 11, 2025

(54) FRAGMENT-BASED DESIGN SEARCH

(71) Applicant: FIGMA, INC., San Francisco, CA (US)

(72) Inventors: Matthew RITTER, San Francisco, CA (US); Richard STEBBING, San Francisco, CA (US); Vincent Mathijs VAN DER MEULEN, San Francisco, CA (US); Matthew DAILEY, San Francisco, CA (US); Daniel CHEN, San Francisco, CA (US); Augustus GRIFFIN, San Francisco, CA (US); Marco CORNACCHIA, San Francisco, CA (US); Jordan SINGER, San Francisco, CA (US); Jasper LU, San Francisco, CA (US); Gino KNODEL, San Francisco, CA (US); Isaac GOLDBERG, San Francisco, CA (US); Deric PANG, San Francisco, CA (US); Rohun GHOLKAR, San Francisco, CA (US); Margaret ZHOU, San Francisco, CA (US); Esther WANG, San Francisco, CA (US); Jared WONG, San Francisco, CA (US)

(21) Appl. No.: 19/063,196

(22) Filed: Feb. 25, 2025

Related U.S. Application Data
(60) Provisional application No. 63/563,800, filed on Mar. 11, 2024.

(51) Int. Cl. G06F 16/2455; G06F 16/22

(52) U.S. Cl. CPC G06F 16/2455; G06F 16/2228

(57) ABSTRACT

A network computer system provides interactive graphic design system instructions for performing fragment-based design search. The network computer system receives a search query specifying a representation of one or more design elements. The network computer system matches one or more embeddings associated with the representation to a set of embeddings for a set of design fragments, wherein each of the one or more design fragments corresponds to a subset of one or more hierarchical structures representing one or more design interfaces. The network computer system generates a set of search results using the set of embeddings and outputs the set of search results in a response to the search query.

### CROSS-REFERENCE TO RELATED APPLICATIONS

This application claims priority benefit of U.S. Provisional Patent Application titled “FRAGMENT-BASED DESIGN SEARCH,” Ser. No. 63/563,800, filed Mar. 11, 2024. The subject matter of this related application is hereby incorporated herein by reference.

### TECHNICAL FIELD

Examples described herein relate to a network computer system, and more specifically, to fragment-based design search in interactive graphic design systems.

### BACKGROUND

Software design tools have many forms and applications. In the realm of application user interfaces, for example, software design tools require designers to blend functional aspects of a program with aesthetics and even legal requirements, resulting in a collection of pages which form the user interface of an application. For a given application, designers often have many objectives and requirements that are difficult to track.

### BRIEF DESCRIPTION OF THE DRAWINGS

FIG. 1 illustrates an interactive graphic design system in accordance with one or more embodiments.

FIG. 2A illustrates the operation of an indexer in accordance with one or more embodiments.

FIG. 2B illustrates the operation of a search engine and search interface in accordance with one or more embodiments.

FIG. 3A illustrates an example search interface for performing fragment-based design search in accordance with one or more embodiments.

FIG. 3B illustrates an example search interface for performing fragment-based design search in accordance with one or more embodiments.

FIG. 4A illustrates a process for generating data structures used in fragment-based design search in accordance with one or more embodiments.

FIG. 4B illustrates a process for performing fragment-based design search in accordance with one or more embodiments.

FIG. 5 illustrates a computer system on which one or more embodiments can be implemented.

FIG. 6 illustrates a user computing device for use with one or more examples, as described.

### DETAILED DESCRIPTION

Examples include a computer system that can operate to implement an interactive graphic design system that enables users to create, update, and/or customize components in a design interface. The design interface can include design elements that are rendered by the integrated graphic design system on a canvas. In examples, a computer system is configured to implement an interactive graphic design system for designers, such as user interface designers (“UI designers”), web designers, and web developers. Among other advantages, examples as described enable such users to search for design interfaces (or portions of design interfaces) that are similar to design elements specified in search queries.

In some examples, a design interface is represented as a set of interconnected nodes arranged in a graph and/or another hierarchical structure. Workspace data for a design interface may include data describing the set of nodes along with data describing the hierarchical structure. Within the hierarchical structure, relationships between nodes may denote an arrangement of layers, where individual layers correspond to a frame object, a group of frame objects, or a specific type of frame object. In context of such examples, nodes in the layers can represent design elements within the design interface. Each node and/or layer can also be characterized by a set of attributes that reflect the visual appearance of the corresponding design element. The attributes of each node and/or layer can be selected or manipulated by users. By way of illustration, a user can modify individual nodes and/or layers by specifying (i) a numeric value to represent a line, corner or dimensional characteristic of a frame object; (ii) a color value (e.g., which can be formatted as HEX, HSB, HSL, CSS and RGB) for a background, or for a fill, line or shading attribute of an object; (iii) a shape characteristic; and/or (iv) a text string attribute.

In some embodiments, hierarchical structures representing a design interface are divided into discrete design fragments. Each design fragment represents a user-interface element, a screen, a collection of related user-interface elements, and/or another “standalone” or “distinct” portion of the design interface. One or more embeddings of the design fragment are generated and mapped to the design fragment in an index, thereby creating a searchable repository that can be queried to find design fragments that match or resemble specified design elements.

To search for design fragments in the index, a user may generate a search query that specifies an image, hand-drawn sketch, text-based description, file, and/or another representation of one or more design elements. One or more embeddings of the representation may be matched to a set of embeddings stored in the index. The matched embeddings may be used to retrieve a set of design fragments from the index. The retrieved design fragment(s) may then be returned as a set of search results in response to the search query.

The search results may additionally be updated and/or refined based on the user's selection of a design fragment within the search results. More specifically, a representation of the selected design fragment may be included in an updated search query, and an embedding of the selected design fragment and/or representation may be used to retrieve an additional set of design fragments that are similar to the selected design fragments. The additional set of design fragments may then be displayed as additional search results to the user, thereby allowing the user to explore the space of attributes associated with design fragments that match a corresponding design element representation and/or combination of design element representations, generate new designs that include the design fragments and/or design elements within the design fragments, and/or perform other operations that can be used to retrieve, reuse, share, and/or modify designs.

Examples may be deployed in a collaborative environment that allows multiple users to concurrently update a design interface, and may streamline the retrieval and management of large design systems and improve the efficient functioning of computers in generating, updating, and navigating across design interfaces. For example, a conventional design tool may lack the ability to search for designs that are similar to a screenshot, sketch, and/or another representation of a design. Instead, a designer may be required to browse a set of thumbnails representing designs to which the designer has access. The designer may also manually go through (e.g., open, view, etc.) individual designs to find screens and/or other design elements that are similar to a given representation of a design.

In contrast, the disclosed interactive graphic design system allows a user to search for portions of designs that are visually or functionally similar to a representation of a design. As a result, the user can efficiently match the representation to similar designs and/or portions of designs without incurring significant time and resource overhead in manually browsing design thumbnails and/or design elements within individual designs. Additionally, the interactive graphic design system is capable of matching screenshots, sketches, and/or other representations of designs to similar portions of designs, thereby allowing the user to search for portions of designs in a flexible, iterative, and format-independent manner.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs, and/or machines.

Some embodiments described herein can generally require the use of computing devices, including processing and memory resources. For example, one or more embodiments described herein may be implemented, in whole or in part, on computing devices such as servers, desktop computers, cellular or smartphones, tablets, wearable electronic devices, laptop computers, printers, digital picture frames, network equipment (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices, and/or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program.

### System Description

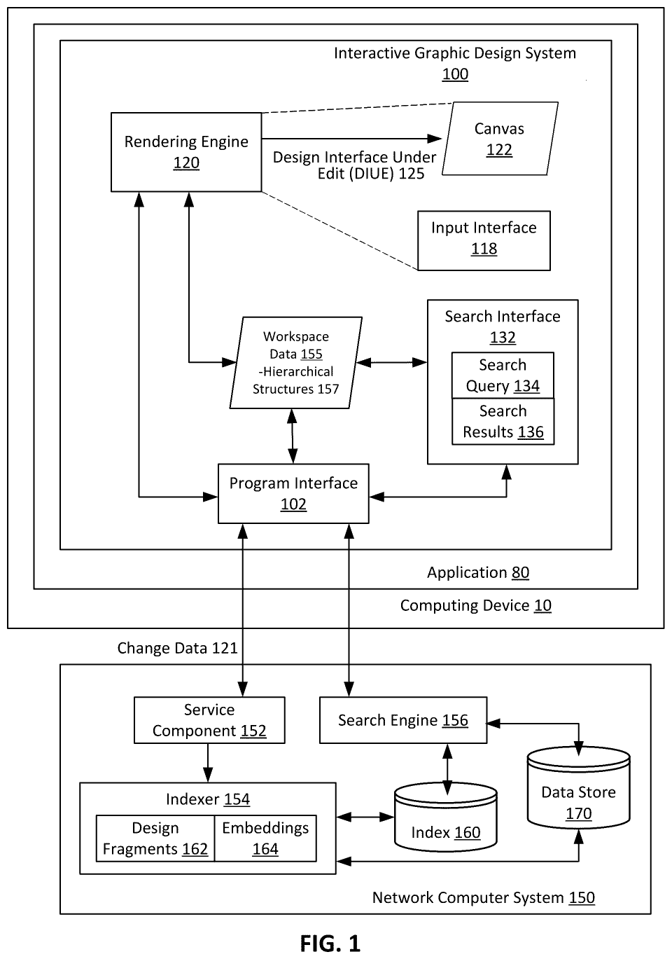

FIG. 1 illustrates an interactive graphic design system (IGDS) 100, according to one or more examples. The IGDS 100 can be implemented in any one of multiple different computing environments, including as a device-side application, as a network service, and/or as a collaborative platform. In examples, the IGDS 100 can be implemented using a web-based application 80 that executes on a web browser of a user computing device 10. In other examples, the IGDS 100 can be implemented through use of a dedicated web-based application. As an addition or alternative, one or more components of the IGDS 100 can be implemented as distributed system, such that processes described with various examples execute on both a network computer (e.g., server) and on the computing device 10.

According to examples, the IGDS 100 can be implemented on a user computing device 10 to enable a corresponding user to create, view, and/or modify various types of design interfaces using graphical elements. A design interface may include any layout of content and/or interactive elements, such as (but not limited to) a web page. The IGDS 100 can include processes that execute as or through a browser application 80 that is installed on the computing device 10.

In examples, the application 80 can correspond to a commercially available browser, such as GOOGLE CHROME (developed by GOOGLE, INC.), SAFARI (developed by APPLE, INC.), and INTERNET EXPLORER (developed by the MICROSOFT CORPORATION). In such examples, the processes of the IGDS 100 can be implemented as scripts and/or other embedded code which web-based application 80 downloads from a network site. For example, the web-based application 80 can execute code that is embedded within a webpage to implement processes of the IGDS 100. The application 80 can also execute the scripts to retrieve other scripts and programmatic resources (e.g., libraries) from the network site and/or other local or remote locations. By way of example, the application 80 may execute JAVASCRIPT embedded in an HTML resource (e.g., webpage structured in accordance with HTML 5.0 or other versions, as provided under standards published by W3C or WHATWG consortiums). In other variations, the IGDS 80 can be implemented through use of a dedicated application, such as a web-based application.

In some examples, application 80 retrieves programmatic resources for implementing the IGDS 100 from a network site. As an addition or alternative, application 80 can retrieve some or all of the programmatic resources from a local source (e.g., local memory residing with the computing device 10). Application 80 may also access various types of data sets in providing functionality such as described with the IGDS 100. The data sets can correspond to files and libraries, which can be stored remotely (e.g., on a server, in association with an account) or locally.

The IGDS 100 can be implemented as web code that executes in the application 80. This web code can include (but is not limited to) HyperText Markup Language (HTML), JAVASCRIPT, Cascading Style Sheets (CSS), other scripts, and/or other embedded code which the browser application 80 downloads from a network site. For example, the application 80 can execute web code that is embedded within a web page, causing the IGDS 100 to execute at the user computer device 10 in the browser application 80. The web code can also cause the application 80 to execute and/or retrieve other scripts and programmatic resources (e.g., libraries) from the network site and/or other local or remote locations. By way of example, the application 80 may include JAVASCRIPT embedded in an HTML resource (e.g., web page structured in accordance with HTML 5.0 or other versions, as provided under standards published by W3C or WHATWG consortiums) that is executed by the browser application 80. In some examples, the rendering engine 120 and/or other components may utilize graphics processing unit (GPU) accelerated logic, such as provided through WebGL (Web Graphics Library) programs which execute Graphics Library Shader Language (GLSL) programs that execute on GPUs.

In examples, the IGDS 100 includes processes that execute through a web-based application 80 that is installed on the computing device 10. The web-based application 80 can execute scripts, code and/or other logic to implement functionality of the IGDS 100. Additionally, in some variations, the IGDS 100 can be implemented as part of a network service, where the application 80 communicates with one or more remote computers (e.g., server used for a network service) to executes processes of the IGDS 100.

In examples, the application 80 loads processes and data for providing the IGDS 100 on the computing device 10. The IGDS 100 can include a rendering engine 120 that enables users to create, edit and update graphic design files.

According to examples, a user of device 10 operates the application 80 to access a network site, where programmatic resources are retrieved and executed to implement the IGDS 100. In this way, the user may initiate a session to implement the IGDS 100 to create, view, and/or modify a design interface. In some embodiments, the IGDS 100 includes a program interface 102, an input interface 118, a search interface 132, and a rendering engine 120. The program interface 102 can include one or more processes that execute to access and retrieve programmatic resources from local and/or remote sources.

The IGDS 100 can include processes represented by program interface 102, rendering engine 120, input interface 118, and search interface 132. Depending on implementation, the components can execute on the computing device 10, on a network system (e.g., server or combination of servers), or on the user device 10 and a network system (e.g., as a distributed process).

In some implementations, the program interface 102 can generate a canvas 122 using programmatic resources that are associated with the browser application 80 (e.g., an HTML 5.0 canvas). As an addition or variation, the program interface 102 can trigger or otherwise cause the canvas 122 to be generated using programmatic resources and data sets (e.g., canvas parameters) which are retrieved from local (e.g., memory) or remote sources (e.g., from network service).

The program interface 102 includes processes to receive and send data for implementing components of the IGDS 100. Additionally, the program interface 102 can be used to retrieve, from local or remote sources, programmatic resources and data sets which include workspace data 155 of the user or user's account. As used herein, the term “workspace data” refers to data describing a design interface that can be loaded by the IGDS 100, the term “design interface under edit” (DIUE) refers to a design interface that is loaded in the IGDS 100, and the term “active workspace data” refers to workspace data describing a DIUE 125 that is loaded in the IGDS 100.

The program interface 102 may also retrieve programmatic resources that include an application framework for use with the canvas 122. The application framework can include data sets that define or configure a set of interactive graphic tools that integrate with the canvas 122. For example, the interactive graphic tools may include an input interface 118 to enable the user to provide input for creating and/or editing a design interface.

According to some examples, the input interface 118 can be implemented as a functional layer that is integrated with the canvas 122 to detect and interpret user input, such as the input interface 118. In one or more embodiments, the input interface 118 includes a user interface that can, for example, use a reference of the canvas 122 to identify a screen location of a user input (e.g., ‘click’). Additionally, the input interface 118 can interpret an input action of the user based on the location of the detected input (e.g., whether the position of the input indicates selection of a tool, an object rendered on the canvas, or region of the canvas), the frequency of the detected input in a given time period (e.g., double-click), and/or the start and end position of an input or series of inputs (e.g., start and end position of a click and drag), as well as various other input types which the user can specify (e.g., right-click, screen-tap, etc.) through one or more input devices. In this manner, the input interface 118 can interpret, for example, a series of inputs as a design tool selection (e.g., shape selection based on location/s of input), as well as inputs to define properties (e.g., dimensions) of a selected shape.

In examples, the workspace data 155 includes one or more data sets that represent a corresponding design interface that is in progress (e.g., DIUE 125) and can be rendered by rendering engine 120. More specifically, the workspace data 155 can include one or more hierarchical structures 157 which collectively define the DIUE. In some examples, the hierarchical structures 157 define a collection of layers, where each layer corresponds to an object, group of objects, or specific type of object. Further, in some examples, the hierarchical structures 157 can represent various screens within a design interface, such as one or more pages (e.g., with one canvas per page) and/or sections that include one or multiple pages.

In some examples, the rendering engine 120 and/or other components utilize graphics processing unit (GPU) accelerated logic, such as provided through WebGL (Web Graphics Library) programs which execute Graphics Library Shader Language (GLSL) programs that execute on GPUs. In variations, the application 80 can be implemented as a dedicated web-based application that is optimized for providing functionality as described with various examples. Further, the application 80 can vary based on the type of user device, including the operating system used by the user device 10 and/or the form factor of the user device (e.g., desktop computer, tablet, mobile device, etc.).

The rendering engine 120 renders the DIUE 125 described by the workspace data 155 on the canvas 122. For example, when a given version of a design interface is selected as the DIUE 125, the rendering engine 120 renders the design interface as described by the corresponding version of workspace data 155. The DIUE 125 includes graphic elements and their respective properties as described by one or more hierarchical structure 157 in the workspace data 155. The user can edit the DIUE 125 using the input interface 118. As an addition or alternative, the rendering engine 120 can generate a blank page for the canvas 122, and the user can use the input interface 118 to generate the DIUE 125. As rendered, the DIUE 125 can include graphic elements such as a background and/or a set of objects (e.g., shapes, text, images, programmatic elements), as well as properties of the individual graphic elements. Each property of a graphic element can include a property type and a property value. For an object, the types of properties include shape, dimension (or size), layer, type, color, line thickness, font color, font family, font size, font style, and/or other visual characteristics. Depending on implementation details, the properties reflect attributes of two- or three-dimensional designs. In this way, property values of individual objects can define visual characteristics such as size, color, positioning, layering, and content for elements that are rendered as part of the DIUE 125. Hierarchical structures 157 within workspace data 155 for the design interface can include nodes and/or layers describing one or more objects belonging to the design interface.

Individual design elements may also be defined in accordance with a desired run-time behavior. For example, some objects can be defined to have run-time behaviors that are either static or dynamic. The properties of dynamic objects may change in response to predefined run-time events generated by the underlying application that is to incorporate the DIUE 125. Additionally, some objects may be associated with logic that defines the object as being a trigger for rendering or changing other objects, such as through implementation of a sequence or workflow. Still further, other objects may be associated with logic that provides the design elements to be conditional as to when they are rendered and/or their respective configuration or appearance when rendered. Still further, objects may also be defined to be interactive, where one or more properties of the object may change based on user input during the run-time of the application.

The input interface 118 can process at least some user inputs to determine input information indicating (i) an input action type (e.g., shape selection, object selection, sizing input, color selection), (ii) an object or objects that are affected by the input action (e.g., an object being resized), (iii) a desired property that is to be altered by the input action, and/or (iv) a desired value for the property being altered. The program interface 102 can receive the input information and implement changes indicated by the input information to update the workspace data 155. The rendering engine 120 can update the canvas 122 to reflect the changes to the affected objects in the DIUE 125. For example, when a given version of the design interface is selected as the DIUE 125, the program interface 102 updates the corresponding version of the workspace data 155, and the rendering engine 120 updates the canvas 122 to reflect changes to the design interface indicated by the input information.

### Collaborative Environment

In examples, the IGDS 100 can be implemented as part of a collaborative platform, where a graphic design can be viewed and edited by multiple users operating different computing devices at locations. As part of a collaborative platform, when a user updates the DIUE 125 and/or workspace data 155 on the computing device 10, the changes made by the user are implemented in real-time to instances of the DIUE 125 and/or workspace data 155 on the computing devices of other collaborating users. Likewise, when other collaborators make changes to the DIUE 125, the changes are reflected in real-time within the hierarchical structures 157. The rendering engine 120 can update the workspace data 155 and/or DIUE 125 in real-time to reflect changes to the graphic design by the collaborators.

In implementation, when the rendering engine 120 implements a change to the workspace data 155 and/or DIUE 125, corresponding change data 121 representing the change can be transmitted to the network computer system 150. The network computer system 150 can implement one or more synchronization processes (represented by a service component 152) to maintain a network-side representation of the workspace data 155. In response to receiving the change data 121 from the computing device 10, the network computer system 150 updates the network-side representation of the workspace data 155 and transmits the change data 121 to user devices of other collaborators. Likewise, if another collaborator makes a change to the instance of the workspace data 155 on their respective device, corresponding change data 121 can be communicated from the collaborator device to the network computer system 150. The service component 152 updates the network-side representation of the workspace data 155 and transmits corresponding change data 121 to the user device 10 to update the hierarchical structures 157 and the DIUE 125.

### Fragment-Based Design Search

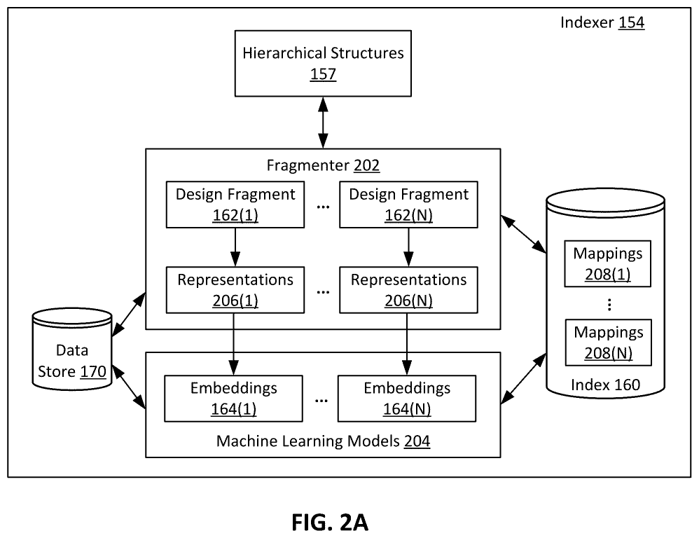

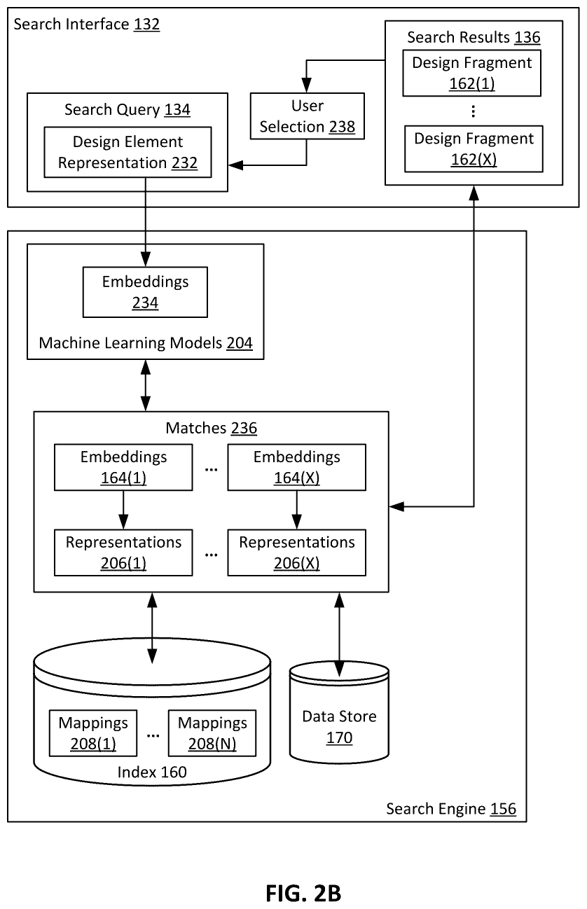

In some embodiments, the IGDS 100 includes functionality to perform fragment-based design search, in which a user can search for design interfaces and/or portions of design interfaces that are similar to representations of one or more design elements. As shown in FIG. 1, the service component 152 transmits a given set of workspace data 155 and/or DIUE 125 to an indexer 154 on the network computer system 150 in response to receiving change data 121 related to the workspace data 155 and/or DIUE 125 from the computing device 10. The indexer 154 divides one or more hierarchical structures 157 in the change data 212, workspace data 155, and/or DIUE 125 into a number of design fragments 162 that represent discrete subsets of a corresponding design interface. The indexer 154 also generates embeddings of the design fragments 162 and stores mappings between the design fragments 162 and the corresponding embeddings 164 in an index 160. The indexer 154 further stores the design fragments 162 and the corresponding embeddings 164 in a data store 170. The operation of the indexer 154 is described in further detail below with respect to FIG. 2A.

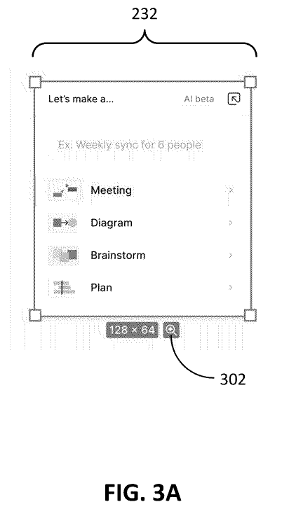

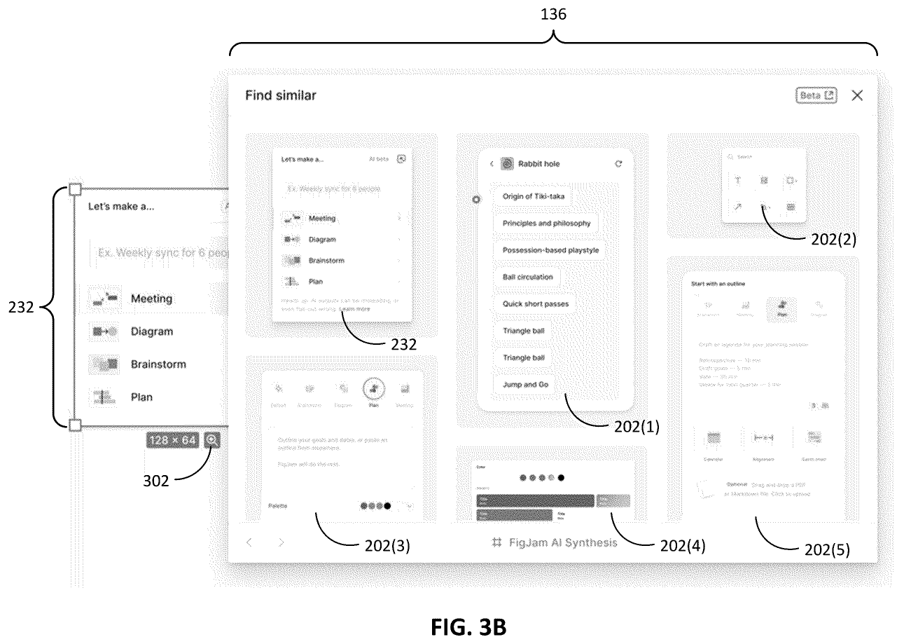

The IGDS 100 also provides a search interface 132 that allows a user to generate a search query 134 specifying a representation of one or more design elements. After the search query 134 is submitted by the user, the search query 134 may be relayed from the search interface 132 via the program interface 102 to a search engine 156 on the network computer system 150. The search engine 156 matches one or more embeddings of the design element(s) to one or more embeddings 164 stored in the index 160. The search engine 156 also retrieves design fragments 162 mapped to the matching embeddings 164 from the index 160 and/or the data store 170 and returns search results 136 that include at least some of the design fragments 162 to the computing device 10. The program interface 102 on the computing device 10 provides the search results 136 to the search interface 132, and the search interface 132 displays and/or outputs the search results 136 to the user. The operation of the search interface 132 and the search engine 156 is described in further detail below with respect to FIGS. 2B and 3A-3B.

FIG. 2A illustrates the operation of the indexer 154 in accordance with one or more embodiments. As mentioned above, the indexer 154 converts hierarchical structures 157 that include changes to one or more design interfaces (e.g., as received by the service component 152 from one or more computing devices) into design fragments 162(1)-162(N). For example, the indexer 154 may divide one or more hierarchical structures 157 into corresponding design fragments 162 upon detecting a new version of the design interface (e.g., a “checkpoint”) after a certain period of inactivity in editing the design interface, after changes to the hierarchical structures 157 have been saved by a user, and/or after other types of changes to the hierarchical structures 157 have been made and/or persisted.

In some embodiments, each design fragment 162 represents a searchable “unit” within a corresponding design interface. For example, each design fragment 162 may include a subset of a hierarchical structure 157 (e.g., one or more nodes, a sub-tree, a sub-graph, etc.) that corresponds to a user-interface element, group of user-interface elements, screen, region within a screen, collection of screens, and/or another portion of the design interface that can be recognized as “standalone” and/or distinct from other portions of the design interface.

In response to changes to one or more hierarchical structures 157, a fragmenter 202 within the indexer 154 divides the hierarchical structures 157 into design fragments 162. For example, the fragmenter 202 may render design elements represented by the hierarchical structures 157 using an instance of the rendering engine 120 (e.g., in a headless browser). The fragmenter 202 may examine the rendered design elements for properties (e.g., node types, dimensions, etc.), structures, and/or other attributes that are indicative of design fragments 162. The fragmenter 202 may also extract nodes that are grouped under the properties, structures, and/or other attributes as corresponding design fragments 162 from the hierarchical structures 157.

In some embodiments, the fragmenter 202 uses a set of rules and/or heuristics to identify individual design fragments 162 as distinct portions of the corresponding design interfaces. For example, the fragmenter 202 may identify dimensions, resolutions, and/or aspect ratios of design elements that correspond to standard device or screen sizes and generate design fragments 162 that are likely to represent user interface screens as collections of nodes associated with the dimensions and/or aspect ratios. In another example, the fragmenter 202 may extract design fragments 162 as groups of connected nodes that share common properties (e.g., color schemes, typography, etc.) that are indicative of a cohesive design. In a third example, the fragmenter 202 may utilize metadata (e.g., layer names, grouping conventions, etc.) to identify meaningful fragments that represent logical subsets a given design interface. In a fourth example, the fragmenter 202 may match shapes, layouts, and/or arrangements of design elements within a set of hierarchical structures 157 to predefined standalone portions of a design interface (e.g., a navigation bar, product card, etc.).

The fragmenter 202 may also, or instead, use one or more machine learning techniques to generate predictions related to design fragments 162. For example, the fragmenter 202 may input one or more hierarchical structures 157, renderings of the hierarchical structures 157, subsets of the hierarchical structures 157, and/or other data associated with the hierarchical structures 157 and/or corresponding design interfaces into one or more machine learning models. In response to the inputted data, the machine learning models divide the hierarchical structures 157 into distinct design fragments 162; generate classification scores indicating the likelihood that various subsets of the hierarchical structures 157 corresponds to individual design elements, a cohesive collection of design elements, and/or a particular type of design element (e.g., a login screen, a type of menu, etc.); and/or generate other output can be used to extract design fragments 162 from the hierarchical structures 157.

The fragmenter 202 may additionally generate design fragments 162 at varying levels of granularity. For example, the fragmenter 202 may extract design fragments 162 corresponding to individual screens, collections of related screens, distinct regions within screens, user-interface elements, groupings of functionally related user-interface elements, and/or other collections of design elements. In another example, the fragmenter 202 may generate design fragments 162 that include top-level nodes within the hierarchical structures 157 with a node type of “Frame” that are direct children of a page and/or “container frame.” The fragmenter 202 may also, or instead, generate design fragments 162 that include lower-level nodes representing design elements that can be found within a “Frame” and/or another type of top-level node.

Moreover, the fragmenter 202 may apply exclusion criteria to prevent non-essential elements from being indexed as design fragments 162. For example, the fragmenter 202 may omit and/or filter scribbles, annotations, and/or other user-generated markup from the design fragments 162.

The fragmenter 202 also generates one or more representations 206(1)-206(N) of the design fragments 162(1)-162(N). These representations 206(1)-206(N) may include (but are not limited to) subsets of hierarchical structures 157 corresponding to the design fragments 162 (e.g., in a standardized file and/or data interchange format), renderings of the design fragments 162, images and/or thumbnails that visually depict the design fragments 162, text-based descriptions of the design fragments 162, layout patterns, style sheets, color palettes, and/or other representations 206 of shapes, visual attributes, styles, and/or arrangements of design elements within the design fragments 162.

The indexer 154 also uses one or more machine learning models 204 to generate embeddings 164(1)-164(N) of the representations 206. For example, the machine learning models 204 may include (but are not limited to) convolutional neural networks (CNNs), recurrent neural networks (RNNs), graph neural networks, fully connected neural networks, residual neural networks, transformer neural networks (e.g., vision transformers, Bidirectional Encoder Representations from Transformers (BERT) neural networks, etc.), autoencoders, variational autoencoders (VAEs), generative adversarial networks (GANs), pre-trained feature extractors, and/or other types of neural networks that are capable of converting images, text, graph-based representations 206, and/or other representations 206 of design fragments 162 into embeddings 164 in a lower-dimensional latent space. In another example, the machine learning models 204 may include one or more components (e.g., text encoder, image encoder, etc.) of a Contrastive Language-Image Pretraining (CLIP) neural network and/or another type of multimodal embedding model that learns a multimodal embedding space associated with images, text, and/or other types of data. These component(s) may be used to convert multiple representations 206 of design fragments 162 into corresponding embeddings 164 within a shared embedding space.

The indexer 154 updates the index 160 with mappings 208(1)-208(N) between the design fragments 162(1)-162(N) and the corresponding embeddings 164(1)-164(N). For example, the indexer 154 may store mappings 208(1)-208(N) in a key-value store corresponding to the index 160, where keys in the key-value store include embeddings 164 and values in the key-value store include identifiers and/or representations 206 of the corresponding design fragments 162. The indexer 154 may also, or instead, store mappings 208(1)-208(N) in a hash index, vector database, and/or another type of data store that allows embeddings 164 to be stored, retrieved, and/or compared.

In one or more embodiments, some or all mappings 208(1)-208(N) in the index 160 represent groups of embeddings 164(1)-164(N) corresponding to similar design fragments 162(1)-162(N). For example, the indexer 154 may use a clustering technique to generate clusters of embeddings 164(1)-164(N) that are within a threshold distance of one another in a corresponding embedding space. For each cluster of embeddings 164(1)-164(N), the indexer 154 may update the index 160 with mappings 208(1)-208(N) between these embeddings 164(1)-164(N) to a cluster identifier for the cluster and/or another indication that the embeddings 164(1)-164(N) belong to the cluster. Representations of the clusters in the index 160 may then be used to process some or all search queries received by the search interface 132, in lieu of or in addition to mappings 208(1)-208(N) associated with individual design fragments 162(1)-162(N).

The indexer 154 additionally stores representations 206 of design fragments 162 and embeddings 164 in the data store 170. For example, the indexer 154 may persist one or more text- and/or image-based representations 206 of each design fragment 162 with the corresponding embeddings 164 and/or other metadata to the data store 170. The index 160 and the data store 170 can then be used by the search interface 132 and the search engine 156 to retrieve design fragments 162 that match design elements specified in search queries.

When changes to hierarchical structures 157 include deletions of files, design interfaces, and/or portions of design interfaces, the indexer 154 may remove corresponding design fragments 162, representations 206, and/or embeddings 164 from index 160 and/or data store 170. Consequently, the indexer 154 may keep index 160 and data store 170 up to date with the latest versions of hierarchical structures 157.

FIG. 2B illustrates the operation of the search engine 156 and search interface 132 in accordance with one or more embodiments. As shown in FIG. 2B, the search interface 132 receives a search query 134 that specifies a design element representation 232 of one or more design elements. The design element representation 232 may include (but is not limited to) one or more images, design interface files, rendered design elements, hand-drawn sketches, text-based descriptions, layout patterns, color palettes, style sheets, and/or other representations of visual attributes, styles, and/or layouts of the design elements.

The search interface 132 also includes functionality to receive a user selection 238 of the design element representation 232. For example, the search interface 132 may include text fields, menus, file selectors, drawable regions, and/or other user-interface elements that allow a user of a corresponding computing device 10 to define, select, create, and/or otherwise indicate the design element representation 232.

The design element representation 232 received from the user may be in the same format and/or a different format from representations 206 of design fragments 162 stored in the index 160. For example, the design element representation 232 received from the user may include an image, a screenshot, at least a portion of a design interface, a file that includes one or more hierarchical structures 157, and/or a text-based description of one or more design elements. The design representation 232 may also, or instead, include a sketch, drawing, and/or another user-generated graphical depiction of the design element(s) that is distinct from representations 206 of design fragments 162 in the index 160.

After the search query 134 is submitted by the user, the search query 134 is transmitted to the search engine 156. In response to the search query 134, the search engine 156 generates one or more embeddings 234 of the design element representation 232 in the search query 134. For example, the search engine 156 may use one or more neural networks to convert the design element representation 232 into one or more corresponding embeddings 234.

The search engine 156 performs a lookup of mappings 208(1)-208(N) in index 160 to generate a set of matches 236 between embeddings 234 of the design element representation 232 and embeddings 164(1)-164(X) of design fragments 162(1)-162(X). In some embodiments, matches 236 are generated using a nearest neighbor search technique that retrieves, from the index 160, embeddings 164(1)-164(X) that are closest to one or more embeddings 234 of the design element representation 232 within a corresponding embedding space. For example, the search engine 156 may use a cosine similarity, Euclidean distance, dot product, and/or another measure of vector distance and/or similarity between one or more embeddings 234 of the design element representation 232 and embeddings 164 stored in the index 160 to retrieve a predetermined number of embeddings 164(1)-164(X) with the greatest similarity to the embedding(s) 234 and/or a variable number of embeddings 164(1)-164(X) that meet or exceed a threshold similarity with the embedding(s) 234.

Matches 236 may also, or instead, include clusters of embeddings 164(1)-164(X) that are similar to one or more embeddings 234 of the design element representation 232. For example, the search engine 156 may use measures of vector distance and/or similarity between one or more embeddings 234 of the design element representation 232 and “representative” embeddings 164(1)-164(X) that correspond to centroids of the clusters (or embeddings 164(1)-164(X) of design fragments 162 that are closest to the centroids of the clusters) to retrieve, from the index 160, one or more clusters with representative embeddings 164(1)-164(X) that have the greatest similarity to the embedding(s) 234 and/or that meet or exceed a threshold similarity with the embedding(s) 234.

After matches 236 between embeddings 234 of the design element representation 232 and embeddings 164(1)-164(X) and/or clusters of embeddings 164(1)-164(X) in index 160 are generated, the search engine 156 retrieves representations 206(1)-206(X) of the corresponding design fragments 162(1)-162(X) and adds the retrieved representations 206(1)-206(X) to the set of matches 236. For example, the search engine 156 may use mappings 208(1)-208(N) that include the embeddings 164(1)-164(X) to retrieve identifiers for the corresponding design fragments 162(1)-162(X). The search engine 156 may then use the design fragment identifiers to retrieve the representations 206(1)-206(X) of the design fragments 162(1)-162(X) from the data store 170.

The search engine 156 generates search results 136 that include representations 206(1)-206(X) of the design fragments 162(1)-162(X) in matches 236 and transmits the search results 136 to the computing device 10 from which the search query 134 was received (and optionally to other computing devices with access to the search query 134 and/or the design element representation 232). The search interface 132 on each computing device 10 displays the search results 136 to a corresponding user, and the user may browse, filter, click on, and/or otherwise interact with the search results 136 to retrieve the corresponding design fragments 162(1)-162(X). The retrieved design fragments 162(1)-162(X) can then be shared, edited, added to other design interfaces, and/or otherwise used to facilitate development and management of designs by the user(s).

The matches 236 and/or search results 136 may additionally be filtered based on access controls and/or permissions associated with the user performing the search query 134 and/or the design fragments 162. For example, the search engine 156 may retrieve, from the index 160, data store 170, and/or another database, permissions associated with design fragments 162 in matches 236. The search engine 156 may use the retrieved permissions to filter and/or omit any design fragments 162 to which the user does not have access from the matches 236 and/or corresponding search results 136 outputted to the user.

In some embodiments, the search interface 132 and the search engine 156 are configured to refine the search results 136 based on a user selection 238 of one or more design fragments 162 within the search results 136. For example, the user may generate the user selection 238 of a given design fragment 162 in the search results 136 (e.g., using a keyboard shortcut, cursor, and/or another specific user input) in a way that triggers the generation of an updated search query 134 that includes a corresponding design element representation 232 of the design fragment 162. The search engine 156 may use embeddings 234 of the design element representation 232 to generate a set of updated matches 236 that include representations 206 of design fragments 162 that are similar to the selected design fragment 162. The search engine 156 may also, or instead, combine (e.g., average, sum, interpolate, etc.) one or more embeddings 234 of the design element representation 232 with one or more embeddings 234 of one or more other design element representations from one or more previous search queries and use the combined embeddings 234 to generate a set of updated matches 236 that include representations 206 of design fragments 162 that are similar to the selected design fragment 162 and the other design element representations from the previous search queries. The search engine 156 may transmit the updated matches 236 as a new set of search results 136 to the computing device 10, and the search interface 132 may display the new search results 136 to the user. The user may also make an additional user selection 238 of a different design fragment 162 in the new search results 136 to further refine the search results 136.

In another example, a given set of search results 136 may include a set of design fragments 162(1)-162(X) that are representative of a set of clusters of embeddings 164(1)-164(X) that are most similar to one or more embeddings 234 of a corresponding design element representation 232. In this example, each “representative” design fragment 162 in the set of search results 136 may be mapped to a corresponding “representative” embedding 164 for a cluster in the index 160. Consequently, the representative design fragment 162 may be included in the search results 136 as an indication of the attributes of the set of design fragments 162 found in the cluster. In turn, the user selection 238 of a given design fragment 162 in the set of search results 136 may trigger the generation of an updated search query 134 that includes the identifier of the corresponding cluster. The search engine 156 may process the updated search query 134 by retrieving matches 236 that include a set of additional sub-clusters of embeddings 164 within the cluster and/or a set of smaller clusters of embeddings 164 that are closest to the centroid of the cluster within an embedding space. The search engine 156 may transmit the updated matches 236 as a new set of search results 136 to the computing device 10, and the search interface 132 may display the new search results 136 to the user. The user may also make an additional user selection 238 of a different design fragment 162 in the new search results 136 to further “drill down” into design fragments 162 that are associated with increasingly smaller clusters of embeddings 164. In both examples, each user selection 238 made from a given set of search results 136 allows the user to explore the space of attributes associated with design fragments 162 that match a corresponding design element representation 232 and/or combination of design element representations, generate new designs that include the design fragments 162 and/or design elements within the design fragments 162, and/or perform other operations that can be used to retrieve, reuse, share, and/or modify designs within the IGDS 100.

### Example Search Interfaces

FIG. 3A illustrates an example search interface 132 for performing fragment-based design search in accordance with one or more embodiments. As shown in FIG. 3A, the search interface 132 includes a design element representation 232 of one or more design elements. For example, the design element representation 232 may include a rendering, screenshot, and/or thumbnail of the design element.

The search interface 132 also includes a button 302 that can be selected to trigger a search for design fragments that are similar to the design element(s). For example, a user selection of the button 302 may cause a search query that includes the design element representation 232 and/or other representations of the design element(s) to be generated and transmitted to the search engine 156.

FIG. 3B illustrates an example search interface 132 for performing fragment-based design search in accordance with one or more embodiments. More specifically, FIG. 3B illustrates the search interface 132 of FIG. 3A after a set of search results 136 has been generated for the search query. In response to receiving the search results 136, the search interface 132 displays a two-dimensional (2D) arrangement that includes the original design element representation 232 and a set of thumbnails 202(1)-202(5). Each thumbnail 202(1)-202(5) may include an image that visually depicts a corresponding design fragment that is determined to be similar to the design element representation 232. The user may select a given thumbnail 202(1)-202(5) to trigger an updated search query that includes a representation of the corresponding design fragment. The updated search query may be used to generate a different set of search results that include design fragments with embeddings that are similar to the embedding of the selected design fragment and/or a combination of the embedding of the design fragment and the embedding of the original design element representation 232. The user may also, or instead, select a given thumbnail 202(1)-202(5) to render the corresponding design fragment, open a file containing the design fragment, import the design fragment into a canvas, and/or otherwise enable access to and/or modification of the design fragment.

### Methodology

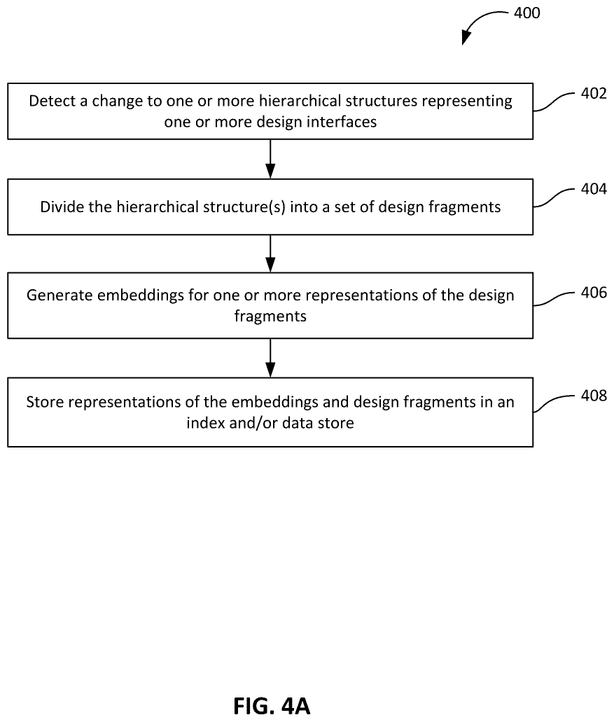

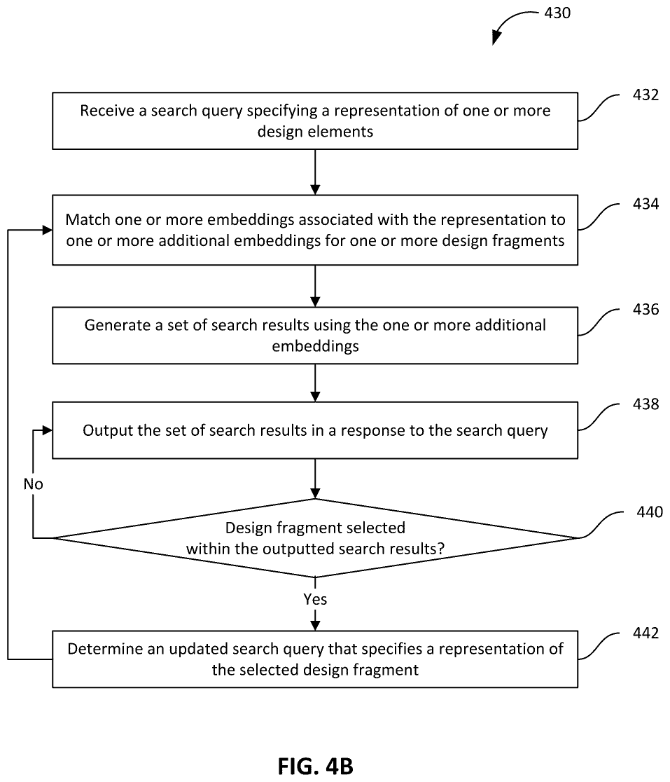

FIG. 4A illustrates a process 400 for generating data structures used in fragment-based design search in accordance with one or more embodiments. Process 400 may be performed by one or more computing devices and/or processes thereof. For example, one or more blocks of process 400 may be performed by a user computing device (e.g., user computing device 10) and/or a network computer system (e.g., network computer system 150, 50).

At block 402, a computing device, which may include (but is not limited to) the user computing device and/or network computer system, detects a change to one or more hierarchical structures representing one or more design interfaces. For example, the computing device may receive an event representing a checkpoint, save, and/or another indication of the change in a file and/or workspace data storing the hierarchical structure(s).

At block 404, the computing device divides the hierarchical structure(s) into a set of design fragments. For example, the computing device may use rules, heuristics, machine learning models, and/or other techniques to generate the design fragments as discrete subsets of the hierarchical structure(s). Each design fragment may represent a user-interface element, group of user-interface elements, screen, region within a screen, collection of screens, and/or another portion of a design interface that can be recognized as “standalone” and/or distinct from other portions of the design interface.

At block 406, the computing device generates embeddings for one or more representations of the design fragments. For example, the computing device may use one or more neural networks, text embedding models, image embedding models, multimodal embedding models, and/or other types of machine learning models and/or techniques to convert text-based definitions, text-based descriptions, images, and/or other representations of the design fragments into embeddings in one or more embedding spaces.

At block 408, the computing device stores representations of the embeddings and design fragments in an index and/or data store. For example, the computing device may store mappings between the embeddings and identifiers for the design fragments in the index. The computing device may also, or instead, store representations of the design fragments and/or the embeddings in the data store. The computing device may also, or instead, store identifiers for clusters to which the embeddings and/or corresponding design fragments belong in the index and/or data store. The index and/or data store may then be used to process search queries for design fragments that are similar to one or more user-specified design elements, as described in further detail below with respect to FIG. 4B.

FIG. 4B illustrates a process 430 for performing fragment-based design search in accordance with one or more embodiments. Process 430 may be performed by one or more computing devices and/or processes thereof. For example, one or more blocks of process 400 may be performed by a user computing device (e.g., computing device 10) and/or a network computer system (e.g., network computer system 150, 50).

At block 432, a computing device, which may include (but is not limited to) the user computing device and/or network computer system, receives a search query specifying a representation of one or more design elements. For example, the computing device may include a search interface that allows a user to generate the search query and/or specify the representation of the design element(s) for inclusion in the search query. In another example, the computing device may include a search engine that receives the search query from a user computing device on which the search interface is provided.

At block 434, the computing device matches one or more embeddings associated with the representation to a set of embeddings for a set of design fragments. For example, the computing device may use one or more machine learning models and/or other techniques to convert the representation into embeddings in one or more lower-dimensional embedding spaces. The computing device may also perform a lookup of an index using the embedding(s) to retrieve a set of similar embeddings and/or a set of clusters with representative embeddings that are similar to the embedding(s) of the representation.

At block 436, the computing device generates a set of search results using the matching set of embeddings. For example, the computing device may use mappings associated with the set of embeddings in the index to retrieve the corresponding design fragment identifiers. The computing device may also use the design fragment identifiers to retrieve the corresponding design fragments from a data store.

At block 438, the computing device outputs the set of search results in a response to the search query. For example, the computing device may display the search results to the user and/or transmit the search results to a different computing device for display to the user.

At block 440, the computing device determines whether or not a design fragment has been selected within the outputted search results. For example, the selection of the design fragment may include a click on the design fragment within the outputted search results, a keyboard shortcut associated with the design fragment, and/or other user input indicating that the design fragment has been selected. If no design fragments have been selected within the outputted search results, the computing device may continue outputting the set of search results in block 438.

If a design fragment has been selected within the outputted search results, the computing device proceeds to block 442 and determines an updated search query that specifies a representation of the selected design fragment. The computing device then repeats blocks 434, 436, and 438 to generate and output a different set of search results for the updated search query. For example, the computing device may determine that a text-based definition, text-based description, and/or image representation of the selected design fragment is included in the search query. The computing device may generate one or more embeddings of the representation and match the embedding(s) to a set of embeddings and/or clusters of embeddings in the index. The computing device may additionally use the index to retrieve design fragments mapped to the matching embeddings and/or clusters. The computing device may further generate and output search results that include representations of the retrieved design fragments. This process of generating and processing updated search queries in response to user selections of design fragments within existing search results allows the user to explore design fragments with different types of similarity to a given set of design elements and/or design fragments and/or refine the search results based on certain attributes of the design fragments.

The computing device may also, or instead, load a file and/or workspace data that includes a design fragment selected within the outputted search results to allow the user to view, edit, copy, and/or otherwise make use of the design fragment and/or a design interface that includes the design fragment. Consequently, the process 430 may allow the user to efficiently locate and retrieve design fragments that are similar to multiple potential representations of design elements, explore design fragments that are similar to one another in a semantically meaningful way, and/or otherwise access design fragments and/or design interfaces within an IGDS in a flexible and format-independent manner.

### Network Computer System

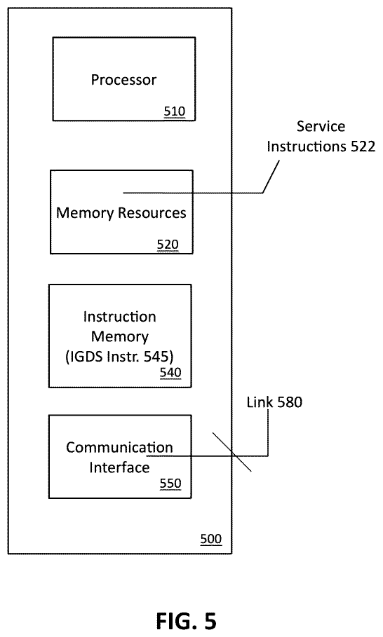

FIG. 5 illustrates a computer system on which one or more embodiments can be implemented. A computer system 500 can be implemented on, for example, a server or combination of servers. For example, the computer system 500 may be implemented as the network computer system 150 of FIG. 1.

In one implementation, the computer system 500 includes processing resources 510, memory resources 520 (e.g., read-only memory (ROM) or random-access memory (RAM)), one or more instruction memory resources 540, and a communication interface 550. The computer system 500 includes at least one processor 510 for processing information stored with the memory resources 520, such as provided by a random-access memory (RAM) or other dynamic storage device, for storing information and instructions which are executable by the processor 510. The memory resources 520 may also be used to store temporary variables or other intermediate information during execution of instructions to be executed by the processor 510.

The communication interface 550 enables the computer system 500 to communicate with one or more user computing devices, over one or more networks (e.g., cellular network) through use of the network link 580 (wireless or a wire). Using the network link 580, the computer system 500 can communicate with one or more computing devices, specialized devices and modules, and/or one or more servers.

In examples, the processor 510 may execute service instructions 522, stored with the memory resources 520, in order to enable the network computer system to implement the service component 152, indexer 154, and search engine 156 and operate as the network computer system 150 in examples such as described with respect to FIG. 1.

The computer system 500 may also include additional memory resources (“instruction memory 540”) for storing executable instruction sets (“IGDS instructions 545”) which are embedded with webpages and other web resources, to enable user computing devices to implement functionality such as described with the IGDS 100.

As such, examples described herein are related to the use of the computer system 500 for implementing the techniques described herein. According to an aspect, techniques are performed by the computer system 500 in response to the processor 510 executing one or more sequences of one or more instructions contained in the memory 520. Such instructions may be read into the memory 520 from another machine-readable medium. Execution of the sequences of instructions contained in the memory 520 causes the processor 510 to perform the process steps described herein. In alternative implementations, hard-wired circuitry may be used in place of or in combination with software instructions to implement examples described herein. Thus, the examples described are not limited to any specific combination of hardware circuitry and software.

### User Computing Device

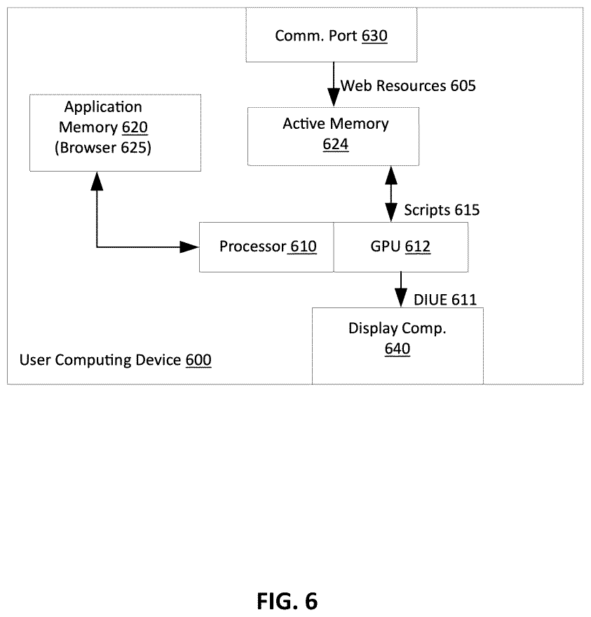

FIG. 6 illustrates a user computing device for use with one or more examples, as described. In examples, a user computing device 600 can correspond to, for example, a workstation, a desktop computer, a laptop, and/or another computer system having graphics processing capabilities that are suitable for enabling renderings of design interfaces and graphic design work. In variations, the user computing device 600 can correspond to a mobile computing device, such as a smartphone, tablet computer, laptop computer, VR or AR headset device, and the like.

In examples, the computing device 600 includes a central or main processor 610, a graphics processing unit 612, memory resources 620, and one or more communication ports 630. The computing device 600 can use the main processor 610 and the memory resources 620 to store and launch a browser 625 or other web-based application. A user can operate the browser 625 to access a network site of the network service, using the communication port 630, where one or more web pages or other resources 605 for the network service (see FIG. 1) can be downloaded. The web resources 605 can be stored in the active memory 624 (cache).

As described by various examples, the processor 610 can detect and execute scripts and other logic which are embedded in the web resource in order to implement the IGDS 100 (see FIG. 1). In some of the examples, some of the scripts 615 which are embedded with the web resources 605 can include GPU accelerated logic that is executed directly by the GPU 612. The main processor 610 and the GPU can combine to render a design interface under edit (“DIUE 611”) on a display component 640. The rendered design interface can include web content from the browser 625, as well as design interface content and functional elements generated by scripts and other logic embedded with the web resource 605. By including scripts 615 that are directly executable on the GPU 612, the logic embedded with the web resource 605 can better execute the IGDS 100, as described with various examples.

### CONCLUSION

Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

### EXAMPLE EMBODIMENTS

CLAUSE 1. A computer system comprising: one or more processors; and a memory to store a set of instructions, wherein the one or more processors execute instructions stored in the memory to perform operations comprising: dividing one or more hierarchical structures representing one or more design interfaces into a plurality of design fragments; updating an index with the plurality of design fragments and a plurality of embeddings for the plurality of design fragments; and processing a search query that specifies one or more design elements using the index.

CLAUSE 2. The computer system of clause 1, wherein the operations further comprise: generating the plurality of embeddings using one or more machine learning models.

CLAUSE 3. The computer system of clause 1 or 2, wherein generating the plurality of embeddings comprises: generating a text-based representation of a design fragment from the plurality of design fragments; and converting the text-based representation into an embedding for the design fragment.

CLAUSE 4. The computer system of any of clauses 1-3, wherein the text-based representation comprises at least one of a text-based description of the design fragment or a text-based definition of the design fragment.

CLAUSE 5. The computer system of any of clauses 1-4, wherein the one or more machine learning models comprise at least one of a text embedding model, an image embedding model, or a multimodal embedding model.

CLAUSE 6. The computer system of any of clauses 1-5, wherein dividing the one or more hierarchical structures into the plurality of design fragments comprises generating a design fragment from a node within the one or more hierarchical structures based on one or more attributes associated with the node.

CLAUSE 7. The computer system of any of clauses 1-6, wherein the one or more attributes comprise at least one of a node type or a dimension.

CLAUSE 8. The computer system of any of clauses 1-7, wherein the design fragment is generated based on a classification score outputted by a machine learning model from a representation of the node.

CLAUSE 9. The computer system of any of clauses 1-8, wherein processing the search query comprises: converting a representation of the one or more design elements into one or more embeddings; matching the one or more embeddings to a set of embeddings in the index; and adding a set of design fragments corresponding to the set of embeddings to a set of search results for the search query.

CLAUSE 10. The computer system of any of clauses 1-9, wherein matching the one or more embeddings to the set of embeddings comprises: matching the one or more embeddings to a set of clusters of embeddings in the index; determining a set of representative design fragments associated with the set of clusters of embeddings; and adding the set of representative design fragments to the set of search results.

CLAUSE 11. The computer system of any of clauses 1-10, wherein processing the search query further comprises: matching a user selection of a design fragment in the set of representative design fragments to a cluster in the set of clusters; and updating the set of search results with one or more additional design fragments in the cluster.

CLAUSE 12. The computer system of any of clauses 1-11, wherein matching the one or more embeddings to the set of clusters of embeddings comprises determining that a similarity between the one or more embeddings and a set of representative embeddings for the set of clusters of embeddings meets or exceeds a threshold.

CLAUSE 13. The computer system of any of clauses 1-12, wherein processing the search query further comprises: determining an embedding for a design fragment that is selected by a user from the set of search results; and generating an additional set of search results based on the embedding.

CLAUSE 14. The computer system of any of clauses 1-13, wherein the operations further comprise detecting a change to the one or more hierarchical structures prior to dividing the one or more hierarchical structures into the plurality of design fragments.

CLAUSE 15. The computer system of any of clauses 1-14, wherein the search query specifies the one or more design elements using at least one of an image, a text-based description, a sketch, or at least a portion of a design interface.

CLAUSE 16. A non-transitory computer-readable medium that stores instructions, executable by one or more processors, to cause the one or more processors to perform operations comprising: receiving a search query specifying a representation of one or more design elements; matching one or more embeddings associated with the representation to a set of embeddings for a set of design fragments, wherein each design fragment in the set of design fragments corresponds to a subset of one or more hierarchical structures representing one or more design interfaces; generating a set of search results using the set of embeddings; and outputting the set of search results in a response to the search query.

CLAUSE 17. The non-transitory computer-readable medium of clause 16, wherein the operations further comprise: generating the one or more embeddings using one or more machine learning models.

CLAUSE 18. The non-transitory computer-readable medium of clause 16 or 17, wherein the one or more machine learning models comprise at least one of a text embedding model, an image embedding model, or a multimodal embedding model.

CLAUSE 19. The non-transitory computer-readable medium of any of clauses 16-18, wherein the one or more embeddings are matched to the set of embeddings based on one or more distances computed between the one or more embeddings and the set of embeddings.

CLAUSE 20. The non-transitory computer-readable medium of any of clauses 16-19, wherein generating the set of search results comprises: determining that the set of embeddings corresponds to representative embeddings for a set of clusters of embeddings; determining a set of representative design fragments associated with the set of clusters of embeddings; and adding the set of representative design fragments to the set of search results.

CLAUSE 21. The non-transitory computer-readable medium of any of clauses 16-20, wherein determining the set of representative design fragments comprises retrieving, from an index, the set of representative design fragments from a set of mappings that include the representative embeddings.

CLAUSE 22. The non-transitory computer-readable medium of any of clauses 16-21, wherein each of the representative embeddings comprises a centroid of a corresponding cluster in the set of clusters.

CLAUSE 23. The non-transitory computer-readable medium of any of clauses 16-22, wherein generating the set of search results further comprises: matching a user selection of a design fragment in the set of representative design fragments to a cluster in the set of clusters; and updating the set of search results with one or more additional design fragments from the cluster.

CLAUSE 24. The non-transitory computer-readable medium of any of clauses 16-23, wherein generating the set of search results comprises: retrieving, from an index, the set of design fragments from a set of mappings that include the set of embeddings; and adding the set of design fragments to the set of search results.

CLAUSE 25. The non-transitory computer-readable medium of any of clauses 16-24, wherein generating the set of search results comprises: determining an embedding for a design fragment that is selected by a user from the set of search results; and generating an additional set of search results based on the embedding.

CLAUSE 26. The non-transitory computer-readable medium of any of clauses 16-25, wherein generating the additional set of search results comprises: matching the embedding to an additional set of embeddings in an index; and adding, to the additional set of search results, an additional set of design fragments mapped to the additional set of embeddings within the index.

CLAUSE 27. The non-transitory computer-readable medium of any of clauses 16-26, wherein generating the additional set of search results comprises: matching an aggregation of the one or more embeddings with the embedding to an additional set of embeddings in an index; and adding, to the additional set of search results, an additional set of design fragments mapped to the additional set of embeddings within the index.

CLAUSE 28. A computer-implemented method comprising: dividing one or more hierarchical structures representing one or more design interfaces into a plurality of design fragments; updating an index with the plurality of design fragments and a plurality of embeddings for the plurality of design fragments; and processing a search query that specifies a representation of one or more design elements using the index.

What is claimed is:

1. A computer system comprising:
one or more processors; and
a memory to store a set of instructions, wherein the one or more processors execute instructions stored in the memory to perform operations comprising:
dividing one or more hierarchical structures representing one or more design interfaces into a plurality of design fragments;
updating an index with the plurality of design fragments and a plurality of embeddings for the plurality of design fragments; and
processing a search query that specifies one or more design elements using the index.

2. The computer system of claim 1, wherein the operations further comprise:
generating the plurality of embeddings using one or more machine learning models.

3. The computer system of claim 2, wherein generating the plurality of embeddings comprises:
generating a text-based representation of a design fragment from the plurality of design fragments; and
converting the text-based representation into an embedding for the design fragment.

4. The computer system of claim 3, wherein the text-based representation comprises at least one of a text-based description of the design fragment or a text-based definition of the design fragment.

5. The computer system of claim 2, wherein the one or more machine learning models comprise at least one of a text embedding model, an image embedding model, or a multimodal embedding model.

6. The computer system of claim 1, wherein dividing the one or more hierarchical structures into the plurality of design fragments comprises generating a design fragment from a node within the one or more hierarchical structures based on one or more attributes associated with the node.

7. The computer system of claim 6, wherein the one or more attributes comprise at least one of a node type or a dimension.

8. The computer system of claim 6, wherein the design fragment is generated based on a classification score outputted by a machine learning model from a representation of the node.

9. The computer system of claim 1, wherein processing the search query comprises:
converting a representation of the one or more design elements into one or more embeddings;
matching the one or more embeddings to a set of embeddings in the index; and
adding a set of design fragments corresponding to the set of embeddings to a set of search results for the search query.

10. The computer system of claim 9, wherein matching the one or more embeddings to the set of embeddings comprises:
matching the one or more embeddings to a set of clusters of embeddings in the index;
determining a set of representative design fragments associated with the set of clusters of embeddings; and
adding the set of representative design fragments to the set of search results.

11. The computer system of claim 10, wherein processing the search query further comprises:
matching a user selection of a design fragment in the set of representative design fragments to a cluster in the set of clusters; and
updating the set of search results with one or more additional design fragments in the cluster.

12. The computer system of claim 10, wherein matching the one or more embeddings to the set of clusters of embeddings comprises determining that a similarity between the one or more embeddings and a set of representative embeddings for the set of clusters of embeddings meets or exceeds a threshold.

13. The computer system of claim 9, wherein processing the search query further comprises:
determining an embedding for a design fragment that is selected by a user from the set of search results; and
generating an additional set of search results based on the embedding.

14. The computer system of claim 1, wherein the operations further comprise detecting a change to the one or more hierarchical structures prior to dividing the one or more hierarchical structures into the plurality of design fragments.

15. The computer system of claim 1, wherein the search query specifies the one or more design elements using at least one of an image, a text-based description, a sketch, or at least a portion of a design interface.

16. A non-transitory computer-readable medium that stores instructions, executable by one or more processors, to cause the one or more processors to perform operations comprising:
receiving a search query specifying a representation of one or more design elements;
matching one or more embeddings associated with the representation to a set of embeddings for a set of design fragments, wherein each design fragment in the set of design fragments corresponds to a subset of one or more hierarchical structures representing one or more design interfaces;
generating a set of search results using the set of embeddings; and
outputting the set of search results in a response to the search query.

17. The non-transitory computer-readable medium of claim 16, wherein the operations further comprise:
generating the one or more embeddings using one or more machine learning models.

18. The non-transitory computer-readable medium of claim 17, wherein the one or more machine learning models comprise at least one of a text embedding model, an image embedding model, or a multimodal embedding model.

19. The non-transitory computer-readable medium of claim 16, wherein the one or more embeddings are matched to the set of embeddings based on one or more distances computed between the one or more embeddings and the set of embeddings.

20. The non-transitory computer-readable medium of claim 16, wherein generating the set of search results comprises:
determining that the set of embeddings corresponds to representative embeddings for a set of clusters of embeddings;
determining a set of representative design fragments associated with the set of clusters of embeddings; and
adding the set of representative design fragments to the set of search results.

21. The non-transitory computer-readable medium of claim 20, wherein determining the set of representative design fragments comprises retrieving, from an index, the set of representative design fragments from a set of mappings that include the representative embeddings.

22. The non-transitory computer-readable medium of claim 21, wherein each of the representative embeddings comprises a centroid of a corresponding cluster in the set of clusters.

23. The non-transitory computer-readable medium of claim 20, wherein generating the set of search results further comprises:
matching a user selection of a design fragment in the set of representative design fragments to a cluster in the set of clusters; and
updating the set of search results with one or more additional design fragments from the cluster.

24. The non-transitory computer-readable medium of claim 16, wherein generating the set of search results comprises:
retrieving, from an index, the set of design fragments from a set of mappings that include the set of embeddings; and
adding the set of design fragments to the set of search results.

25. The non-transitory computer-readable medium of claim 16, wherein generating the set of search results comprises:
determining an embedding for a design fragment that is selected by a user from the set of search results; and
generating an additional set of search results based on the embedding.

26. The non-transitory computer-readable medium of claim 25, wherein generating the additional set of search results comprises:
matching the embedding to an additional set of embeddings in an index; and
adding, to the additional set of search results, an additional set of design fragments mapped to the additional set of embeddings within the index.

27. The non-transitory computer-readable medium of claim 25, wherein generating the additional set of search results comprises:
matching an aggregation of the one or more embeddings with the embedding to an additional set of embeddings in an index; and
adding, to the additional set of search results, an additional set of design fragments mapped to the additional set of embeddings within the index.

28. A computer-implemented method comprising:
dividing one or more hierarchical structures representing one or more design interfaces into a plurality of design fragments;
updating an index with the plurality of design fragments and a plurality of embeddings for the plurality of design fragments; and
processing a search query that specifies a representation of one or more design elements using the index.
